(19) United States
(12) Patent Application Publication
(10) Pub. No.: US 2024/0066975 A1
(43) Pub. Date: Feb. 29, 2024

(54) COOLING MODULE FOR AN ELECTRIC OR HYBRID MOTOR VEHICLE, HAVING A TANGENTIAL-FLOW TURBOMACHINE

(71) Applicant: Valeo Systemes Thermiques, Le Mesnil-Saint-Denis (FR)

(72) Inventors: Amrid Mammeri, Le Mesnil-Saint-Denis Cedex (FR); Kamel Azzouz, Le Mesnil-Saint-Denis Cedex (FR); Sebastien Garnier, Le Mesnil-Saint-Denis Cedex (FR); Issiaka Traore, Le Mesnil-Saint-Denis Cedex (FR)

(73) Assignee: Valeo Systemes Thermiques, Le Mesnil-Saint-Denis (FR)

(21) Appl. No.: 18/270,977

(22) PCT Filed: Dec. 16, 2021
(86) PCT No.: PCT/EP2021/086236

§ 371 Date: Jul. 5, 2023

(30) Foreign Application Priority Data
Jan. 5, 2021 (FR) 2100072

(51) Int. Cl. B60K 11/04; B60K 11/08

(52) U.S. Cl. CPC B60K 11/04; B60K 11/08

(57) ABSTRACT

Cooling module (22) for a motor vehicle (10), the module being intended to allow an airflow (F) to pass through from an air inlet (22a) to an air outlet (22b) and comprising a fairing (40) forming a duct which extends between an upstream end (40a) and a downstream end (40b) and inside which at least one heat exchanger (24, 26, 28) is arranged, the fairing (40) comprising at least one junction wall (410) defining the duct, the junction wall (410) comprising a suction opening (01, 02, 03) forming the air inlet (22a) arranged upstream of the heat exchanger(s) (24, 26, 28), the cooling module also comprising a manifold box (41) located next to the downstream end (40b), the manifold box (41) being configured to receive a tangential-flow turbomachine (30) which is configured to generate the airflow (F), the manifold box (41) also comprising the air outlet (22b).

The present invention relates to a cooling module for an electric or hybrid motor vehicle, having a tangential-flow turbomachine.

A cooling module (or heat-exchange module) of a motor vehicle conventionally comprises at least one heat exchanger and a ventilation device which is designed to generate a flow of air in contact with the at least one heat exchanger. The ventilation device thus makes it possible, for example, to generate a flow of air in contact with the heat exchanger, when the vehicle is stationary or running at low speed.

In motor vehicles with a conventional thermal engine, the at least one heat exchanger has a substantially square form, with the ventilation device then being a bladed fan, the diameter of which is substantially equal to the side of the square formed by the heat exchanger.

Conventionally, the heat exchanger is then placed facing at least two cooling openings, formed in the front face of the body of the motor vehicle. A first cooling opening is situated above the fender while a second opening is situated below the fender. Such a configuration is preferred since the thermal engine must also be supplied with air, the air intake of the engine conventionally being located in the passage of the air flow passing through the upper cooling opening. The cooling openings are generally protected by a radiator grille

However, electric vehicles are preferably provided only with cooling openings which are situated below the fender, since the electric motor does not need to be supplied with air. The motor vehicle can be provided with a single cooling opening situated below the fender, or need not comprise a cooling opening at all. More particularly, it is possible to conceive of an electric motor vehicle without a radiator grille

The decrease in the number of cooling openings and the possible lack of a radiator grille make it possible to improve the aerodynamic characteristics of the electric vehicle. This also results in better range and a higher top speed of the motor vehicle. However, the lack of a radiator grille can impede the circulation of air in the cooling module, which can thus reduce its performance levels greatly.

The objective of the present invention is thus to eliminate at least partly the disadvantages of the prior art, and to propose an improved cooling module making it possible to circulate a flow of air through the exchanger(s) even in the absence of a radiator grille and/or a cooling opening.

The present invention thus concerns a cooling module for an electric or hybrid motor vehicle, said cooling module being designed to have a flow of air passing through it from an air inlet to an air outlet, and comprising a fairing forming an inner duct in a longitudinal direction of the cooling module, the inner duct extending between an upstream end and a downstream end which are opposite one another, and in the interior of which there is positioned at least one heat exchanger which is designed to have the flow of air passing through it, the fairing comprising at least one junction wall delimiting the inner duct, the cooling module also comprising a collector housing positioned downstream from the fairing in the longitudinal direction and juxtaposed at the downstream end, said collector housing being configured to receive a tangential-flow turbomachine which itself is configured to generate the flow of air, the collector housing also comprising the air outlet, the junction wall of the cooling module comprising one or a plurality of suction openings forming the air inlet, and one of said suction openings being positioned upstream from the at least one heat exchanger.

The invention can further comprise one or more of the following aspects taken alone or in combination:
the fairing comprises a front wall which blocks the upstream end;
the fairing comprises an opening delimiting the downstream end;
the cooling module comprises at least two heat exchangers positioned in the inner duct in the longitudinal direction;
at least one so-called primary suction opening is positioned upstream from the heat exchanger juxtaposed at the upstream end;
the at least one junction wall comprises at least one so-called secondary suction opening positioned between two juxtaposed heat exchangers;
the cooling module comprises at least one blocking device which is movable between a position of opening and a position of closure of said at least one suction opening;
the cooling module comprises a control unit which is configured to control the blocking device;
the control unit is also configured to position and immobilize the blocking device in at least one intermediate position during displacement of said blocking device between its open position and its blocking position;
the at least one blocking device comprises at least one pivoting shutter which is configured to pivot around an axis of pivoting, and is designed to block the at least one suction opening;
the control unit is configured to control each pivoting shutter independently;
the at least one suction opening forming the air inlet perforates the upper wall of the fairing of the cooling module;
the at least one suction opening forming the air inlet perforates the lower wall of the fairing of the cooling module; and
the fairing forming the inner duct in a longitudinal direction comprises four junction walls, including an upper wall and a lower wall positioned opposite one another, as well as two lateral walls.

Other characteristics and advantages of the present invention will become more clearly apparent from reading the following description, provided by way of non-limiting illustration, and from the appended drawings in which:

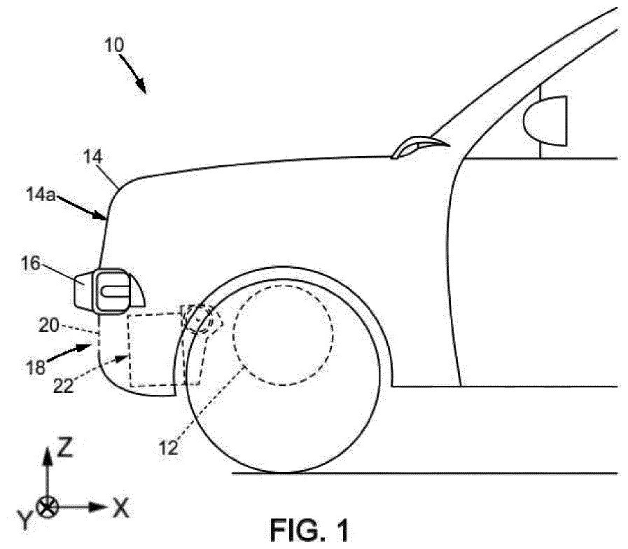

FIG. 1 shows a schematic representation of the front of a motor vehicle in side view;

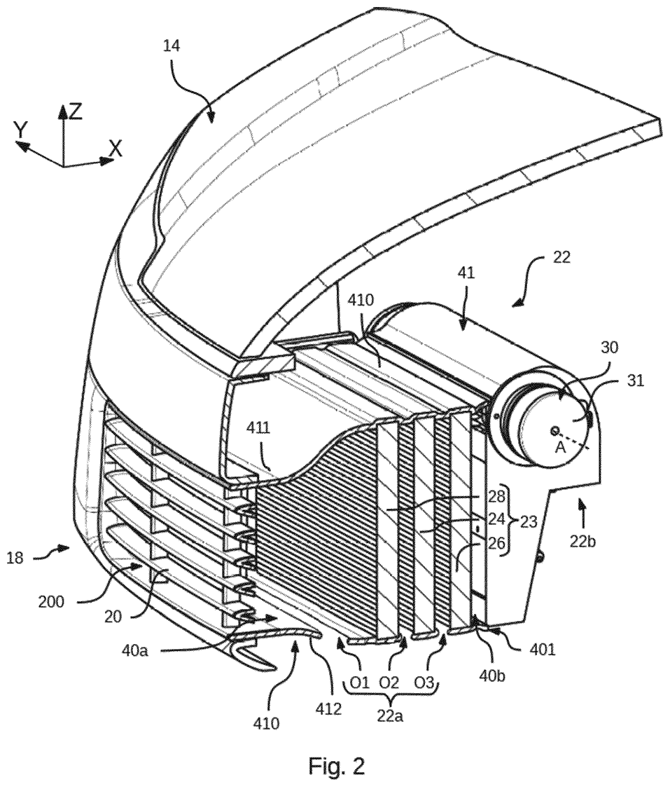

FIG. 2 shows a schematic representation in perspective and in partial cross-section of the front of a motor vehicle and of a cooling module according to a first embodiment;

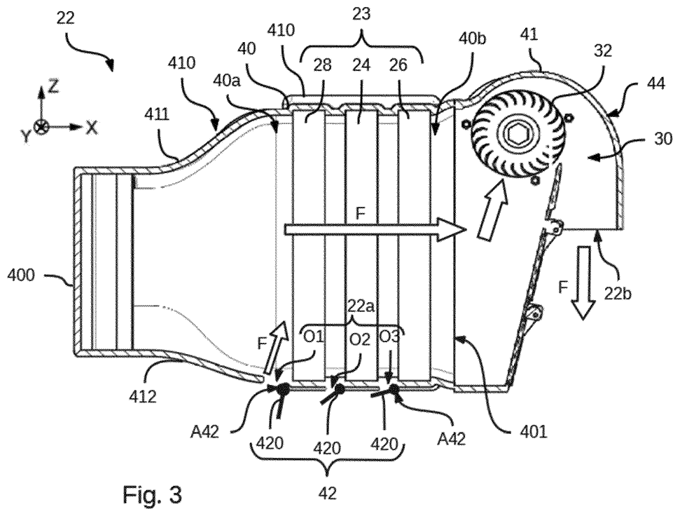

FIG. 3 shows a schematic representation in cross-section of a cooling module according to a second embodiment; and

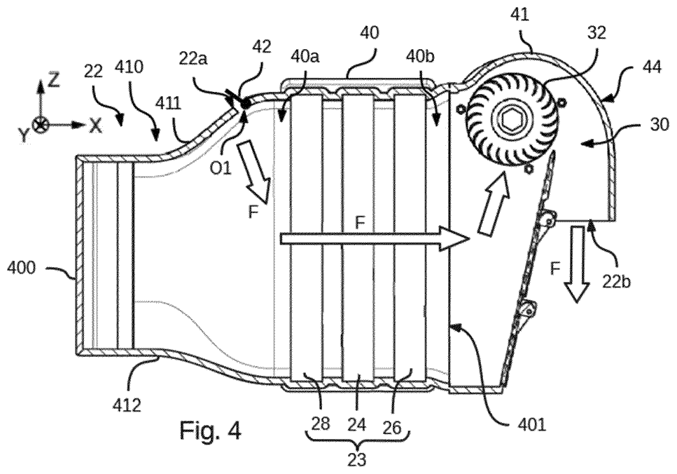

FIG. 4 shows a schematic representation in cross-section of a cooling module according to a third embodiment.

In the various figures, identical elements bear the same reference numbers.

The following embodiments are examples. Although the description refers to one or more embodiments, this does not necessarily mean that each reference relates to the same embodiment, or that the characteristics apply only to one single embodiment. Simple characteristics of different embodiments can also be combined and/or interchanged to provide other embodiments.

In the present description, some elements or parameters can be indexed, such as, for example, first element or second element, as well as first parameter and second parameter or also first criterion and second criterion, etc. In this case, the indexing is simply to differentiate between, and denote, elements or parameters or criteria that are similar, but not identical. Nor does this indexing imply priority of one element, parameter or criterion relative to another and such denominations can easily be interchanged without departing from the scope of the present description. Nor does this indexing imply any chronological order, for example, in assessing any given criterion.

In FIGS. 1 to 4, a trihedron XYZ is shown in order to define the orientation of the various elements in relation to one another. A first direction, denoted X, corresponds to a longitudinal direction of the vehicle. It also corresponds to a direction opposite to the direction of forward movement of the vehicle. A second direction, denoted Y, is a lateral or transverse direction. Finally, a third direction, denoted Z, is vertical. The directions X, Y, Z are orthogonal in pairs.

In all of the figures, the cooling module according to the present invention is illustrated in a functional position, i.e. when it is positioned within a motor vehicle.

FIG. 1 schematically illustrates the front part of an electric or hybrid motor vehicle 10 which can comprise an electric motor or hybrid engine 12. The vehicle 10 notably comprises a body 14 and a fender 16 which are supported by a chassis (not represented) of the motor vehicle 10. A cooling module 22 is positioned below the fender 16 and facing the underbody of the motor vehicle 10. Optionally, the front face 14a of the body 14 can define a cooling opening 18, i.e. an opening through the body 14. This cooling opening 18 preferably faces the cooling module 22. A radiator grille 20 can optionally protect this cooling module 22.

As shown in FIGS. 2 to 4, the cooling module 22 is designed to have a flow of air F passing through it substantially parallel to the direction X going from the front to the rear of the vehicle 10. The direction X corresponds more particularly to the longitudinal axis of the cooling module 22, and the flow of air F circulates from an air inlet 22a to an air outlet 22b. In the present application, an element which is positioned further forward or rearward than another element is referred to respectively as being “upstream” or “downstream”, in the longitudinal direction X of the cooling module 22. The front corresponds to the front of the motor vehicle 10 in the assembled state. The rear, for its part, corresponds to the rear of the motor vehicle 10, or to the face of the cooling module 22 via which the flow of air F is intended to exit from the cooling module 22.

Similarly, “upper” and “lower” mean an orientation in the direction Z. A so-called upper element will be closer to the roof of the vehicle 10, and a so-called lower element will be closer to the ground.

The cooling module 22 substantially comprises fairing 40 forming an inner duct between an upstream end 40a and a downstream end 40b which are opposite one another. This inner duct is preferably oriented parallel to the direction X, such that the upstream end 40a is oriented towards the front of the vehicle 10, and such that the downstream end 40b is oriented towards the rear of the vehicle 10. At least one heat exchanger 24, 26, 28 is positioned in the interior of said fairing 40. In FIGS. 2 to 4, the cooling module 22 comprises three heat exchangers 24, 26, 28 which are grouped within a set of heat exchangers 23, but the module could however comprise more or fewer exchangers depending on the configuration required.

In all the embodiments of the cooling module 22 illustrated in FIGS. 2 to 4, the fairing 40 comprises an opening 401 delimiting the downstream end 40b, and at least one junction wall 410 delimiting the inner duct.

According to a first embodiment of the cooling module 22 illustrated in FIG. 2, the module comprises an opening 200 at its upstream end 40a such as to delimit this end. In particular, this opening 200 is situated facing the radiator grille 20, in the case when the grille is present on the front face 14a of the motor vehicle 10.

According to the embodiments of the cooling module 22 illustrated in FIGS. 3 and 4, the fairing can comprise a front wall 400 which blocks the upstream end 40a, and there is therefore no opening 200 as in the preceding embodiment. In these particular embodiments, the front face 14a of the motor vehicle 10 is in particular without a radiator grille 20, and the aerodynamics of the motor vehicle 10 can thus be optimized.

The at least one junction wall 410 of the fairing 40 also comprises at least one suction opening O1, O2, O3 forming an air inlet 22a which allows air to penetrate in the interior of the cooling module 22.

At least one suction opening, known as the main opening O1 is positioned upstream from the at least one heat exchanger 24, 26, 28, such that the air which penetrates via this main suction opening O1 passes through the set 23 of heat exchangers 24, 26, 28. According to a particular embodiment of the cooling module 22, the module comprises at least two heat exchangers 24, 26, 28 which are positioned in the inner duct in the longitudinal direction X. The at least one main suction opening O1 is thus positioned upstream from the heat exchanger 28 juxtaposed at the upstream end 40a.

As a complement, it is possible to conceive that the at least one junction wall 410 comprises at least one so-called secondary suction opening O2, O3 positioned between two adjacent heat exchangers 24, 26, 28, as illustrated in particular in FIGS. 2 and 3. Thus, a first secondary opening O2 can be positioned between the heat exchangers 28 and 24, and a second secondary opening O3 can be positioned between the heat exchangers 24 and 26. A secondary suction opening O2, O3 of this type positioned between two adjacent heat exchangers 24, 26, 28 makes it possible to introduce cooler air into the heat exchanger which is positioned downstream therefrom, which can optimize the heat exchange thereof.

A first heat exchanger 24 can for example be configured to release heat energy from the flow of air F. This first heat exchanger 24 can more particularly be a condenser connected to a cooling circuit (not represented), for example in order to cool the batteries of the vehicle 10. This cooling circuit can for example be an air-conditioning circuit able to cool the batteries and an internal flow of air destined for the motor vehicle interior.

A second heat exchanger 26 can also be configured to release heat energy into the flow of air F. This second heat exchanger 26 can more particularly be a radiator which is connected to a heat control circuit (not represented) for electrical elements, such as the electric motor 12. Since the first heat exchanger 24 is generally a condenser of an air-conditioning circuit, the circuit needs the flow of air F to be as “cool” as possible in air-conditioning mode. For this purpose, the second heat exchanger 26 is preferably positioned downstream from the first heat exchanger 24 in the direction of circulation of the flow of air F. It is nevertheless entirely conceivable for the second heat exchanger 26 to be positioned upstream from the first heat exchanger 24.

The third heat exchanger 28 can for its part also be configured to release heat energy into the flow of air. This third heat exchanger 28 can more particularly be a radiator connected to a heat control circuit (not represented), which can be separate from the one connected to the second heat exchanger 26, for electrical elements such as the power electronics. It is also entirely conceivable for the second 26 and the third 28 heat exchangers to be connected to a single heat control circuit, for example connected in parallel with one another.

Again according to the example illustrated in FIGS. 2 to 4, the second heat exchanger 26 is positioned downstream from the first heat exchanger 24, whereas the third heat exchanger 28 is positioned upstream from the first heat exchanger 24. Other configurations can nevertheless be envisaged, such as, for example, the second 26 and third 28 heat exchangers both positioned downstream or upstream from the first heat exchanger 24.

In the embodiment illustrated, each of the heat exchangers 24, 26, 28 has a generally parallelepiped form which is determined by a length, a thickness and a height. The length extends in the direction Y, the thickness extends in the direction X, and the height extends in the direction Z. The heat exchangers 24, 26, 28 thus extend on a general plane parallel to the vertical direction Z and the lateral direction Y. This general plane is thus perpendicular to the longitudinal direction X of the cooling module 22, and the heat exchangers 24, 26, 28 are therefore perpendicular to the flow of air F which is intended to pass through them.

In the particular embodiments illustrated in FIGS. 2 to 4, the fairing 40 which forms the inner duct is complementary to the general parallelepiped form of the at least one heat exchanger 24, 26, 28. The fairing 40 thus comprises four junction walls 410, including an upper wall 411 and a lower wall 412 positioned opposite one another, as well as two lateral walls (not shown in the figures) which connect the upper wall 411 to the lower wall 412. The upper wall 411 and the lower wall 412 extend in particular on a plane which is substantially parallel to the plane generated by the axes X and Y, whereas the two lateral walls extend on a plane which is substantially parallel to the plane generated by the axes X and Z. In this particular case, the inner duct has a rectangular or square cross-section.

According to embodiments which are not illustrated in the figures, the inner duct can have a cross-section with a form different from that of a quadrilateral. In particular, the cross-section of the inner duct can be in the form of a hexagon (in this case the fairing 40 comprises six junction walls 410), an octagon (in this case the fairing 40 comprises eight junction walls 410), or also a circular form (in this case the fairing 40 has a cylindrical form and comprises a single junction wall 410 which forms the casing of the cylinder). The cross-section of the inner duct depends mainly on the geometry of the at least one heat exchanger 24, 26, 28 positioned in this inner duct, in the interior of the fairing 40.

According to the embodiments of the cooling module 22 illustrated in FIGS. 2 and 3, the at least one suction opening O1, O2, O3 perforates a lower part of the fairing 40 of the cooling module 22, for example the lower wall 412. In this case, it is the air which is present at the underbody of the vehicle which enters the cooling module 22 via the at least one suction opening O1, O2, O3 in order to form the flow of air F which is intended to circulate through the at least one heat exchanger 24, 26, 28 before being delivered by the air outlet 22b.

According to another embodiment of the cooling module 22 illustrated in FIG. 4, the at least one suction opening O1, O2, O3 which forms the air inlet 22a perforates an upper part of the fairing 40, for example the upper wall 411. In this case, the body 14 defines a cooling opening 18, i.e. an opening through the body 14 in order to allow the air to pass in the vicinity of the body 14 as far as the at least one suction opening O1, O2, O3. In the example illustrated in FIG. 4, only one main suction opening O1 is represented in the upper part of the fairing 40. However, it is altogether possible to conceive of an embodiment which also has at least one secondary suction opening positioned in this upper part of the fairing 40.

In addition, the cooling module 22 can comprise at least one closing device 42, which is movable between a position of opening and a position of closure of said at least one suction opening O1, O2, O3. The at least one closing device 42 can in particular comprise at least one pivoting shutter 420 which is configured to pivot around an axis of pivoting A42 (shown in FIG. 3) and is designed to close the at least one suction opening O1, O2, O3. In particular, there can be one pivoting shutter 420 per suction opening O1, O2, O3. The pivoting shutter(s) 420 can be butterfly valves or flag valves.

In addition, the cooling module 22 can comprise a control unit (not represented in the figures) which is configured to control the closing device 42. The control unit can be configured to position and immobilize the closing device 42 in at least one intermediate position during displacement of said closing device 42 between its open position and its closing position.

The angle of inclination of the pivoting shutters 420 makes it possible to regulate the flow of air F which penetrates in the interior of the cooling module 22 by means of the air inlet 22a formed by the suction opening(s) O1, O2, O3 within the junction walls 410 of the fairing 40. Thus, the flow of air F which circulates through the heat exchanger(s) 24, 26, 28 can be adjusted according to the performance levels required from said heat exchangers 24, 26, 28.

In addition, the control unit can be configured to control each pivoting shutter 420 independently. It is thus possible to conceive of configurations wherein one or more pivoting shutters 420 block the suction opening O1, O2, O3 to which they are attached, whereas other pivoting shutters 420 adopt a position of opening or also an intermediate position, thus influencing the quantity of air which passes through the suction opening(s) 01, O2, O3. A configuration of this type is illustrated in particular in FIG. 3, in which the pivoting shutter 420 situated upstream from the third heat exchanger 28 is represented in its open position, the pivoting shutter 420 situated upstream from the first heat exchanger 24 is represented in its intermediate position, and the pivoting shutter 420 situated upstream from the second heat exchanger 26 is represented in its closed position.

The edges of the at least one suction opening O1, O2, O3 which are designed to come into contact with the edge(s) of the closing device 42 can comprise one or more seals. This seal/these seals can make it possible to absorb the shock of the impact of the edges of the closing device 42 on the edge(s) of the at least one suction opening O1, O2, O3 when the closing device 42 begins to move to its position of closure. The seal(s) can be produced by overmolding of the edge(s) of the at least one suction opening O1, O2, O3. Alternatively, the seal(s) can be added-on parts. In addition, the edge(s) of the closing device 42 can also comprise at least one seal. This at least one seal can be produced by overmolding, or it can be an added-on part.

The cooling module 22 also comprises a collector housing 41 which is positioned downstream from the fairing 40 and the set 23 of heat exchangers 24, 26, 28. More specifically, the collector housing 41 is juxtaposed at the downstream end 40b of the fairing 40, and is thus aligned with the fairing 40 along the longitudinal axis X of the cooling module 22. This collector housing 41 comprises the air outlet 22b which is designed to deliver the flow of air E The collector housing 41 thus makes it possible to recuperate the flow of air F which passes through the set of heat exchangers 23, and to orient this flow of air F towards the air outlet 22b. This is illustrated in particular by the arrows representing the flow of air F in FIGS. 3 and 4. The collector housing 41 can be integral with the fairing 40 or it can be an added-on part secured on the downstream end 40b of said fairing 40.

The cooling module 22, and more specifically the collector housing 41, also comprises at least one tangential-flow fan, also known as a tangential-flow turbomachine 30, which is configured such as to generate the flow of air F which passes through the set of heat exchangers 23. The tangential-flow turbomachine 30 comprises a rotor or a turbine 32 (also known as a tangential-flow helix). The turbine 32 has a substantially cylindrical shape. The turbine 32 advantageously comprises a plurality of stages of blades (or vanes), which are visible in FIG. 3. The turbine 32 is fitted such as to rotate around an axis of rotation A which is for example parallel to the direction Y. The diameter of the turbine 32 is for example between 35 mm and 200 mm in order to limit its size. The tangential-flow turbomachine 30 is thus compact.

The tangential-flow turbomachine 30 can also comprise a motor 31 (visible in FIG. 2) configured to rotate the turbine 32. The motor 31 can for example rotate the turbine 32 at a speed of between 200 rpm and 14,000 rpm. This notably makes it possible to limit the noise generated by the tangential-flow turbomachine 30.

The tangential-flow turbomachine 30 is positioned in the collector housing 41. The tangential-flow turbomachine 30 is then configured to aspirate air in order to generate the flow of air F passing through the set 23 of heat exchangers. The tangential-flow turbomachine 30 more specifically comprises a volute 44, which is formed by the collector housing 41 and at the center of which the turbine 32 is positioned. The volute 44 delimits at least partly the air outlet 22b of the flow of air. In other words, the discharge of air from the volute 44 corresponds to the air outlet 22b of the flow of air F of the collector housing 41.

In the example illustrated in all of FIGS. 2 to 4, the tangential-flow turbomachine 30 is in a high position, notably in the upper third of the collector housing 41, preferably in the upper quarter of the collector housing 41. This notably makes it possible to protect the tangential-flow turbomachine 30 in the event of submersion, and/or to limit the space taken up by the cooling module 22 in its lower part. In this case, the air outlet 22b of the flow of air F is preferably oriented towards the lower part of the cooling module 22.

It is nevertheless conceivable for the tangential-flow turbomachine 30 to be in a low position, notably in the lower third of the collector housing 41. This would make it possible to limit the space taken up by the cooling module 22 in its upper part. In this case, the air outlet 22b of the flow of air F would preferably be oriented towards the upper part of the cooling module 22. Alternatively, the tangential-flow turbomachine 30 can be in a median position, in particular in the median third of the height of the first collector housing 41, for example for reasons of integration of the cooling module 22 into its surroundings. These alternatives are not illustrated. The invention is not limited to the embodiments described with reference to the figures, and further embodiments will be clearly apparent to persons skilled in the art. In particular, the various examples can be combined, provided they are not contradictory.

1. A cooling module for a motor vehicle with an electric or hybrid motor, said cooling module being designed to have a flow of air passing through it from an air inlet to an air outlet, and comprising:
a fairing forming an inner duct in a longitudinal direction of the cooling module, the inner duct extending between an upstream end and a downstream end are opposite one another, and in the interior of which there is positioned at least one heat exchanger which is designed to have the flow of air passing through it, the fairing comprising at least one junction wall delimiting the inner duct;
a collector housing positioned downstream from the fairing in the longitudinal direction and juxtaposed at the downstream end, said collector housing being configured to receive a tangential-flow turbomachine which itself is configured to generate the flow of air, the collector housing also comprising the air outlet;
wherein the junction wall comprises one or a plurality of suction openings forming the air inlet, and in that at least one of said suction openings is positioned upstream from the at least one heat exchanger.

2. The cooling module as claimed in claim 1, characterized in that the fairing comprises a front wall which blocks the upstream end and an opening delimiting the downstream end.

3. The cooling module as claimed in claim 1, further comprising: at least two heat exchangers positioned in the inner duct in the longitudinal direction, and wherein at least one so-called primary suction opening is positioned upstream from the heat exchanger juxtaposed at the upstream end.

4. The cooling module as claimed in claim 3, characterized in that the at least one junction wall comprises at least one so-called secondary suction opening positioned between two juxtaposed heat exchangers.

5. The cooling module as claimed in claim 1, further comprising: at least one blocking device which is movable between a position of opening and a position of closure of said at least one suction opening.

6. The cooling module as claimed in claim 5, further comprising: a control unit which is configured to control the blocking device.

7. The cooling module as claimed in claim 6, wherein the control unit is also configured to position and immobilize the blocking device in at least one intermediate position during displacement of said blocking device between its open position and its blocking position.

8. The cooling module as claimed in claim 6, wherein the at least one blocking device comprises at least one pivoting shutter which is configured to pivot around an axis of pivoting, and is designed to block the at least one suction opening, and wherein the control unit is configured to control each pivoting shutter independently.

9. The cooling module as claimed in claim 1, wherein the at least one suction opening forming the air inlet perforates an upper part of the fairing of the cooling module.

10. The cooling module as claimed in claim 1, wherein the at least one suction opening forming the air inlet perforates a lower part of the fairing of the cooling module.
